(19) United States
(12) Patent Application Publication
(10) Pub. No.: US 2004/0059527 A1
(43) Pub. Date: Mar. 25, 2004

(54) Electric appliance, computer apparatus, intelligent battery, battery diagnosis method, program, and storage medium

(75) Inventors: Masaki Kobayashi, Tokyo-to (JP); Atsushi Kumaki, Yokohama-shi (JP); Shigefumi Odaohhara, Yamato-shi (JP); Mizuho Tadokoro, Yamato-shi (JP)

Correspondence Address: IBM Corporation, Personal and Printing Systems Group Legal Dept., Dept. 9CCA/Bldg. 002-2, P.O. Box 12195, Research Triangle Park, NC, 27709, US

(73) Assignee: International Business Machines Corporation, Armonk, NY

(21) Appl. No.: 10/247,603

(22) Filed: Sep. 19, 2002

(51) Int. Cl. G06F 19/00

(52) U.S. Cl. 702/63

(57) ABSTRACT

To guide a user in making a suitably timed start on refreshment of a battery for supplying power to a main unit by being discharged after being charged. There are provided a CPU for executing a program for diagnosis of an intelligent battery 52, an embedded controller 41 which receives an identifier from the intelligent battery 52 and outputs the identifier to the CPU, an information file in which information on dates of refreshment in a plurality of batteries are stored, and an AC adapter power stop circuit 80 for supplying/stop supplying power from an AC adapter 51 to the main unit. The CPU obtains from the information file the date information corresponding to an identifier output from the embedded controller 41 and makes determination as to necessity to perform refreshment. The AC adapter power stop circuit 80 is controlled on the basis of a refreshment instruction from the CPU to stop supply of power from the AC adapter 51 to the system main unit.

### BACKGROUND OF THE INVENTION

The present invention relates to an electric appliance having a battery which can be used while being repeatedly charged and discharged and, more particularly, to an electric appliance designed so that a battery is suitably refreshed.

Various electric appliances, e.g., information terminal devices, typified by a notebook type personal computer (notebook PC), Personal Digital Assistants (PDA), MiniDisc (MD) devices, and video cameras are supplied with utility power or power from batteries (storage batteries, secondary batteries) each capable of being used a number of times while being repeatedly charged and discharged. As such batteries, nickel-hydrogen batteries and nickel-cadmium batteries (nicad batteries) having a comparatively large capacity and low-priced are used. Lithium-ion batteries having an energy density per unit weight higher than that of nickel-cadmium batteries, lithium polymer batteries using a solid-state polymer without using a liquid electrolyte, etc., also exist.

In nickel-hydrogen batteries and nickel-cadmium batteries, if incomplete discharge and charge are repeatedly performed by stopping discharge halfway, a memory effect occurs such that the apparent charge capacity is reduced and the time during which the battery can be continuously used is shortened. It is known that the capacity of the battery reduced by such a memory effect can be restored fairly close to the full capacity by repeating adequate discharge and charge two or three times. Thus, even in a case where a memory effect occurs in a battery, the battery can recover after being adequately charged and discharged. However, it is necessary to perform detection of the memory effect as a precondition for the battery recovery operation.

In a memory effect detection method presently known, e.g., one adopted for BQ2060 from Texas Instruments Inc. (formerly Benchmarq), the number of times shallow discharge is repeated is counted and a memory effect is assumed to occur in correspondence with a shallow discharge detection count of, for example, 30.

The above-described method, however, entails a drawback in that a condition not to be considered a memory effect may be recognized as a memory effect since the recognition is based only on the number of counts of incomplete discharge, and that there is also a possibility of failure to detect an actual memory effect. Moreover, there are many users who are so anxious about a memory effect as to frequently perform refreshment. It is possible to limit occurrence of a memory effect by frequently performing the refreshing operation, but an adverse effect on the battery life is thereby caused.

On the other hand, if a battery is left detached from a system for a long time or if the system is not used during a long time while the battery is connected to the system, an error in the remaining capacity of the battery due to self discharge becomes considerably large. If such a capacity error exists, an accurate indication of the remaining capacity cannot be given to a user and there is a need to improve the accuracy of the remaining capacity by minimizing the capacity error. Refreshment of the battery whose remaining capacity is to be indicated is effective in minimizing the capacity error. However, it is difficult to adapt the conventional method of refreshment based on the number of counts of repeated shallow discharge to refreshment for reducing a capacity error.

The present invention has been achieved to solve the above-described technical problems and an object of the present invention is to guide a user in use of a battery so that the user can perform properly timed refreshment of the battery.

Another object the present invention is to enable the remaining capacity of a battery to be accurately grasped.

### SUMMARY OF THE INVENTION

To attain the above-described problems, the present invention provides an electric appliance which is arranged so that a rechargeable battery can be connected thereto, and which has a main unit supplied with electric power from the battery, the appliance including identifier recognition means for recognizing an identifier for identification of the battery, information storage means for storing information on the date of execution of refreshment of the battery by relating the information to the identifier recognized by the identifier recognition means, output means for urging a user to execute refreshment of the battery after a lapse of a predetermined time period from the date indicated by the information stored in the information storage means, instruction receiving means for receiving a refreshment instruction from a user, and refreshment execution means for executing refreshment of the battery on the basis of the refreshment instruction received by the instruction receiving means.

An electronic appliance to which the present invention is applied may be arranged as an appliance characterized by having a main unit which consumes electric power, and a battery which supplies electric power to the main unit by being charged and discharged, wherein an error in the remaining capacity of the battery due to self discharge is predicted and guidance on refreshment is performed to remove the error.

The main unit may be specially arranged to perform refreshment guidance in a case where the battery is not refreshed during a predetermined period. Advantageously, an error-free indication of the remaining capacity can be given to a user in a certain cycle by doing so.

The electric appliance to which the present invention is applied is characterized in that a display for demanding refreshment is produced after a lapse of a predetermined time period from the last execution of refreshment of the battery regardless of the number of counts of charge and discharge of the battery.

Further, the electric appliance to which the present invention is applied is characterized by having date information storage means for storing information on the date of the last execution of refreshment of the battery, and determination means for making a determination as to necessity to perform refreshment, the determination means determining that there is a need for refreshment after a lapse of a predetermined time period from the date indicated by the information stored in the date information storage means.

In another aspect, the present invention provides a computer apparatus which is arranged so that a rechargeable battery can be connected thereto, and which has a system main unit supplied with electric power from an AC adapter connected to a commercial power supply and/or from the battery, the computer apparatus characterized by having a CPU for executing a program for diagnosis of the battery, a controller which receives from the battery an identifier for identification of the battery, and which outputs the received identifier to the CPU, an information file in which, for example, information on the dates of refreshment of a plurality of batteries is stored, and an AC adapter power stop circuit which supplies/stops electric power from the AC adapter to the system main unit under the control of the controller, wherein the CPU makes a determination as to necessity to perform refreshment by obtaining the date information corresponding to the identifier output from the controller, and the controller stops supply of electric power from the AC adapter to the system main unit by controlling the AC adapter power stop circuit on the basis of a refreshment instruction from the CPU.

Also, the computer apparatus to which the present invention is applied is characterized by having a memory for storing date information on the date of the last execution of refreshment of the battery, and display means for producing a display for recommending a user to perform refreshment in a case where refreshment of the battery is not performed during a predetermined time period after the date indicated by the date information stored in the memory.

The present invention may also be grasped as an intelligent battery connected to an electric appliance and charged and discharged to supply electric power to the electric appliance. This intelligent battery is characterized by having date information storage means for storing information on the date of refreshment, determination means for making a determination as to necessity to perform refreshment, the determination means determining that there is a need for refreshment after a lapse of a predetermined time period from the date indicated by the information stored in the date information storage means, and output means for outputting the result of determination made by the determination means to a controller of the electric appliance.

The present invention may also be grasped as a program for realizing predetermined functions in a computer to which a battery charged and discharged to supply electric power to a main unit can be connected, and as a storage medium on which such a program is stored. The program is characterized by realizing, in the computer, a function for reading out, from a predetermined memory, information on the date of refreshment of the battery, a function for determining that there is a need for refreshment of the battery in a case where a predetermined time period has elapsed from the date indicated by the information read out, a function for producing an output for urging a user to perform refreshment, a function for receiving a refreshment instruction from the user, and a function for storing information on the date of newly performed refreshment in the memory.

The program may comprise one stored in a computer memory or the like to realize the above-described functions. A similar program may be stored in a storage medium formed so as to be readable by the computer. A method for providing such programs may be such that, for example, a program stored on a storage medium such as a CD-ROM is read by a storage medium reading unit, e.g., a CD-ROM drive. Also, such programs may be installed in computers from a program transfer apparatus through a network, e.g., the Internet.

### BRIEF DESCRIPTION OF THE DRAWING

FIG. 1 is a diagram showing a hardware configuration of a computer system to which the present invention is applied;

FIG. 2 is a diagram showing a circuit configuration of a power supply system;

FIG. 3 is a diagram showing processings under a battery diagnosis program (utility program) for determination as to necessity to perform refreshment;

FIG. 4 is a flowchart showing an example of a process of performing a refreshment guidance function in accordance with the present invention;

FIG. 5 is a flowchart showing an example of detection of occurrence of a memory effect in an intelligent battery; and

FIG. 6 is a diagram showing an example of an on-screen display for guiding a user in executing refreshment.

### DESCRIPTION OF THE PREFERRED EMBODIMENT

The present invention will be described in detail with respect a preferred embodiment thereof with reference to the accompanying drawings.

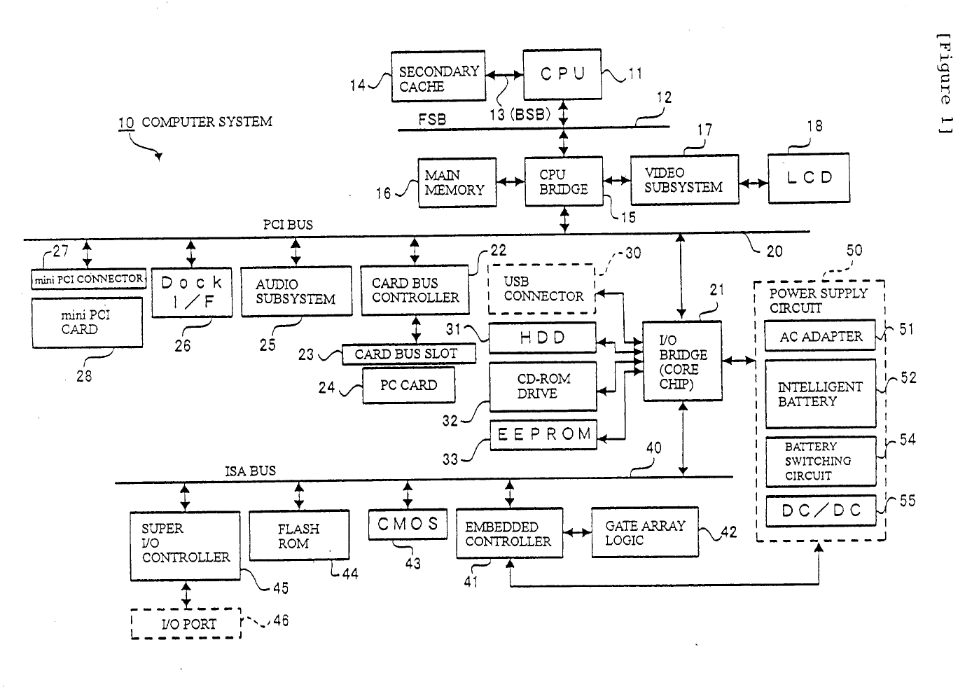

FIG. 1 is a diagram showing a hardware configuration of a computer system 10 to which the present invention is applied. A computer apparatus having the computer system 10 is configured as a notebook-type personal computer (notebook PC) on which a predetermined operating system (OS) in accordance with the Open Architecture Developer's Group (OADG) specifications.

In the computer system 10 shown in FIG. 1, a CPU 11 functions like brains to control the entire computer system 10, and executes a utility program and various programs under the control of the OS. The CPU 11 are connected to other components of the system by buses in three stages: a front side bus (FSB) 12 provided as a system bus, a Peripheral Component Interconnect (PCI) bus 20 provided as a high-speed I/O bus, and an Industry Standard Architecture (ISA) bus 40 provided as a low-speed I/O bus. To increase the processing speed of the CPU 11, program codes and data are stored in a cache memory. A memory configuration recently used is such that a SRAM of about 128 Kbytes is incorporated as a primary cache in the CPU 11 and a secondary cache 14 of about 512 K to 2 M bytes is connected to the CPU 11 by a dedicated bus, shown as a back side bus (BSB) 13, to compensate for a deficiency of capacity. A method of reducing the number of terminals of the CPU package by removing the BSB 13 and connecting the secondary cache 14 to the FSB 12 may be used to reduce the cost of the system.

The FSB 12 and the PCI bus 20 are connected by a CPU bridge (host-PCI bridge) 15 called a memory/PCI chip. The CPU bridge 15 has a memory controller function for controlling the operation for access to the main memory 16 and includes a data buffer for absorbing the difference between the data transfer speeds of the FSB 12 and the PCI bus 20. The main memory 16 is a writable memory used as an area to which a program executed by the CPU 11 is read or a work area to which data processed under an executed program is written. For example, the main memory 16 is constituted by a plurality of DRAM chips, has a capacity of 64 MB in standard form, and is expandable to 320 MB. Programs executed by the CPU 11 include the OS, various drivers for hardware operations of peripheral devices, application programs intended for particular tasks, and firmware such as a basic input/output system (BIOS) stored in a flash ROM 44 described below.

A video subsystem 17 is a subsystem for realizing video functions. The video subsystem 17 includes a video controller which executes a drawing instruction from the CPU 11, writes processed drawing information to a video memory, reads out this drawing information from the memory, and outputs this information as drawing data to a liquid crystal display (LCD) 18.

The PCI bus 20 is a bus capable of transferring data at a comparatively high rate. The PCI bus 20 is standardized by specifications such that the data bus width is 32 bits or 64 bits, the maximum operating frequency is 33 MHz or 66 MHz, and the maximum data transfer rate is 132 MB/sec or 528 MB/sec. To the PCI bus 20 are respectively connected an I/O bridge 21, a card bus controller 22, an audio subsystem 25, a docking station interface (Dock I/F) 26, and a mini PCI connector 27.

The card bus controller 22 is a special controller for direct connection of bus signals from the PCI bus 20 to an interface connector (card bus) in a card bus slot 23. A PC card 24 can be inserted in the card bus slot 23. The docking station interface 26 is a piece of hardware for connection of a docking station (not shown) which is a unit for function expansion of the computer system 10. When the notebook PC is set on the docking station, various hardware units connected to an internal bus of the docking station are connected to the PCI bus 20 through the docking station interface 26. A mini PCI (mini PCI) card 28 is connected to the mini PCI connector 27.

The I/O bridge 21 has a function of bridging between the PCI bus 20 and the ISA bus 40. The I/O bridge 21 also has a DMA controller function, a programmable interrupt controller (PIC) function, a programmable interval timer (PIT) function, an integrated device electronics (IDE) interface function, a universal serial bus (USB) function, and a system management bus (SMB) interface function. Also, the I/O bridge 21 incorporates a real-time clock (RTC).

The DMA controller function is a function for executing data transfer between the main memory 16 and a peripheral device such as a FDD without intervention of the CPU 11. The PIC function is a function for executing a predetermined program (interrupt handler) in response to an interrupt request from a peripheral device. The PIT function is a function for generating a timer signal in a predetermined cycle. To the interface realized by the IDE interface function, an IDE hard disk drive (HDD) 31 is connected and a CD-ROM drive 32 is also connected by the AT attachment packet interface (ATAPI). A different type of IDE device such as a digital versatile disc (DVD) drive may be connected in place of the CD-ROM drive 32. Each of the HDD 31, the CD-ROM drive 32 and other external storage devices is accommodated in an accommodation section called a “media bay” or “device bay” in the body of the notebook PC. These external storage devices provided as standard accessories may be attached exclusively and interchangeably with other devices such as a FDD and a battery pack.

A USB port is provided in the I/O bridge 21. This USB port is connected to a USB connector 30 provided, for example, in a wall portion of the body of the notebook PC. To the I/O bridge 21 is further connected to an EEPROM 33 for storing information such as password or supervisor password registered by a user, a product serial number, etc. The EEPROM 33 is a nonvolatile memory capable of electrically rewriting contents stored therein.

Further, the I/O bridge 21 is connected to a power supply circuit 50, which includes an AC adapter 51 for AC/DC conversion connected to, for example, a commercial power supply of AC 100 V, an intelligent battery 52 (secondary battery), a battery switching circuit 54 for charging the intelligent battery 52 and for switching power supply lines from the AC adapter 51 and the intelligent battery 52, and a DC/DC converter (DC/DC) 55 for producing constant DC voltages of, for example, +15 V, +5 V, and +3.3 V used in the computer system 10.

On the other hand, in a core chip constituting the I/O bridge 21 are provided an internal register for management of the state of power supply in the computer system 10, and a logic (state machine) for management of the state of power supply in the computer system 10 including the operation of this internal register. This logic exchanges various signals with the power supply circuit 50 and recognizes, from this signal exchange, the actual state of power supply from the power supply circuit 50. The power supply circuit 50 controls supply of electric power to the computer system 10 in accordance with instructions from the logic.

ISA bus 40 is a bus of a transfer rate lower than that of the PCI bus 20 (the ISA bus 40 having a bus width of 16 bits and a maximum data transfer rate of 4 MB/sec, for example). To the ISA bus 40 are connected an embedded controller 41 connected to a gate array logic 42, a CMOS 43, the flash ROM 44, and a super I/O controller 45. The ISA bus 40 is also used to connect a peripheral device such as a keyboard/mouse controller having comparatively low operating speed. An I/O port 46 is connected to the super I/O controller 45 to control drive of an FDD, parallel data input/output (PIO) through a parallel port, and serial data I/O (SIO) through a serial port.

The embedded controller 41 controls a keyboard (not shown). The embedded controller 41 is connected together with the gate array logic 42 to the power supply circuit 50 to perform some of power management control functions by an incorporated power management controller (PMC).

Next a power supply system which characterizes this embodiment will now be described.

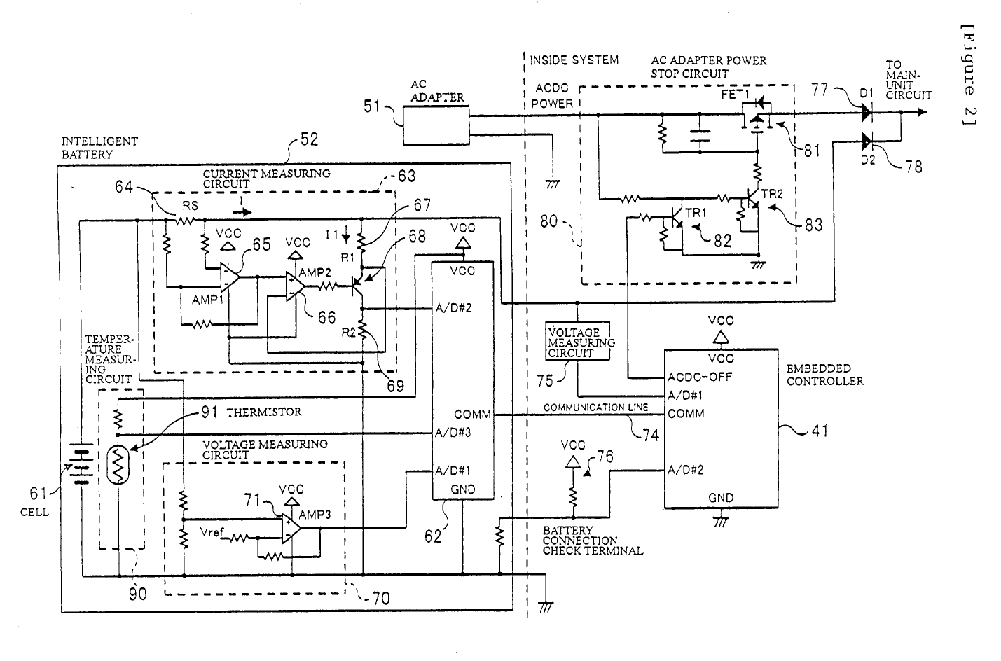

FIG. 2 is a diagram showing a circuit configuration of a power supply system to which the present invention is applied. This power supply system is formed by adding the embedded controller 41, an AC adapter power stop circuit 80, etc., to the power supply circuit shown in FIG. 1.

The power supply system shown in FIG. 2 includes the AC adapter 51, which is a power supply unit connected to a commercial power supply, and the intelligent battery 52, which is a secondary battery system constituted by a nickel-hydrogen battery, a nickel-cadmium battery or the like used by being repeatedly charged and discharged, and which is in conformity with the Smart Battery System (SBS). Power from the AC adapter 51 and the intelligent battery 52 is output to the main-unit system circuit in the computer system 10 via the DC/DC converter shown in FIG. 1.

The power supply system shown in FIG. 2 has, on the main-unit system side, the embedded controller 41, which communicates with the intelligent battery 52 over a communication line 74, a voltage measuring circuit 75, which measures a voltage at the time of excessive discharge and notifies the embedded controller 41 of the measured voltage, and a battery connection check terminal 76 for checking whether the intelligent battery 52 is connected at the time of excessive discharge. The power supply system also has the AC adapter power stop circuit 80, which stops supply of power from the AC adapter 51 to the main-unit system on the basis of an instruction from the embedded controller 41 to refresh the intelligent battery 52, and first and second diodes (D1) 77 and (D2) 78, which rectify a current from the AC adapter 51 and a current from the intelligent battery 52, respectively, to avoid conflict between power supply from the AC adapter 51 and power supply from the intelligent battery 52.

The AC adapter 51, which is a power supply unit, is ordinarily provided outside the body of an appliance, e.g., the notebook PC incorporating the main-unit (internal) system, i.e., the computer system 10. In some case, however, it is provided inside the body of an electric appliance. The main-unit system may be configured so as to have an AC inlet or a DC inlet into which a cable connector, for example, is detachably inserted. The AC inlet or a DC inlet is formed so that, if the AC adapter 51 is provided outside, a connector projecting from a cable connected to the AC adapter is detachably inserted and, if the AC adapter 51 is provided inside the main-unit system, a connector directly connected from a commercial power supply is detachably inserted. The intelligent battery 52 is may be of a type such as to be detachable as a battery pack from the main-unit system or may be provided inside the body of the electric appliance.

An internal configuration of the intelligent battery 52 will next be described. As shown in FIG. 2, the intelligent battery 52 has a group of single cells 61 each capable of being charged and discharged, a CPU 62 which controls intelligent battery 52 and communicates with the embedded controller 41 over the communication line 74, a current measuring circuit 63 for measuring the value of a charging or discharging current through the intelligent battery 52, a voltage measuring circuit 70 for measuring the voltage across the group of cells 61, and a temperature measuring circuit 90 for measuring the temperature of the cells 61. The cells 61 are, for example, six nickel-hydrogen or nickel-cadmium battery cells: three in series in each of two parallel rows (1.8 Ah/cell).

The CPU 62 incorporated in this intelligent battery 52 perform analog to digital (A/D) conversion of analog signals supplied as measuring results from the current measuring circuit 63, the voltage measuring circuit 70 and the temperature measuring circuit 90 to grasp information on the battery, e.g., information on the capacity of the battery. It also stores information on an identifier (serial number) of the battery. The grasped information on the battery and the serial number is transmitted to the embedded controller 41 on the system side over the communication path, i.e., the communication line 74 by using, for example, the SBS protocol.

In the current measuring circuit 63, a potential difference is first produced as a voltage of I×RS across a resistor (RS) 64 by a current I flowing from the cells 61. This voltage is differentially amplified by an operational amplifier (AMP1) 65. A current I1 proportional to the output voltage of the operational amplifier (AMP1) 65 is caused to flow through a resistor (R1) 67 by an operational amplifier (AMP2) 66 and a transistor 68. The value of current I of the intelligent battery 52 can be finally converted into the voltage I1×R2 generated cross the resistor (R2) 69. This voltage (I1×R2) is output to an A/D#2 port of the CPU 62 to be A/D converted in the CPU 62.

In the voltage measuring circuit 70, the voltage of the intelligent battery 52 is measured. More specifically, the voltage across the group of cells 61 in the intelligent battery 52 is converted by being differentially amplified by an operational amplifier (AMP3) 71 to drop temporary to a lower level and is delivered to an A/D#1 port of the CPU 62 to be A/D converted in the CPU 62.

In the temperature measuring circuit 90, a thermistor (thermal sensor) 91 voltage divided by a resistor is placed in the vicinity of the cells 61, as shown in FIG. 2, and a voltage generated across the thermistor 91 is delivered to an A/D#3 port of the CPU 62. The voltage from the thermistor 91 is thus read to the CPU 62 and AND converted in the CPU 62 to measure the temperature. In this manner, information on the temperature in the cells can be grasped in the intelligent battery 52.

The CPU 62 thus reads the charge/discharge current measured with the current measuring circuit 63, the battery voltage measured with the voltage measuring circuit 70, the temperature information obtained from the temperature measuring circuit 90 to manage the capacity, etc., of the intelligent battery 52 (cells 61). The CPU 62 also transmits data on the battery to the embedded controller 41 over the communication line 74. The embedded controller 41 operates on the basis of the grasped condition of the battery to execute, for example, control to make the AC adapter power stop circuit 80 stop power supply from the AC adapter 51.

The system shown in FIG. 2 is arranged to execute a guidance function with respect to the intelligent battery 52 having the CPU 62 provided in a battery pack, for example. However, a dumb battery without internal CPU 62 may be used instead of the intelligent battery 52 and a guidance function may be executed with respect to the dumb battery. The dumb battery may be arranged so as to have its serial number or the like stored in a PROM or the like for discrimination from others. Preferably, a current measuring circuit for measuring dumb battery charge and discharge currents and a voltage measuring circuit for measuring the voltage of the dumb battery are provided on the main-unit system side (in the system) to enable the embedded controller 41 to grasp the condition of the dumb battery including the battery capacity.

It is known that if incomplete discharge and charge are repeatedly performed on a nickel-hydrogen battery or a nickel-cadmium battery by stopping discharge halfway, a “memory effect” occurs such that the apparent charge capacity is reduced and the time during which the battery can be continuously used is shortened. By considering this, the system is arranged to count the number of times incomplete charge and discharge have been performed and to urge a user to execute “refreshment” for completely discharging the battery when it is supposed from the count (e.g., 20 to 30) that a memory effect has occurred in the battery. This refreshment is performed by supplying power from the battery to the system even when the AC adapter 51 is connected.

The AC adapter power stop circuit 80 will next be described.

The AC adapter power stop circuit 80 has a function of stopping power supply from the AC adapter 51. The main-unit system, i.e., the computer system 10, is arranged so that electric power can be supplied from one of the AC adapter 51 and the secondary battery or intelligent battery 52 higher in voltage than the other to the main-unit circuit by means of the first diode 77 and the second diode 78. When the AC adapter 51 is connected, power is supplied from the AC adapter 51 to the main-unit circuit via the first diode 77 since the voltage on the AC adapter side 51 is usually higher than that on the intelligent battery 52 side.

At this step, when a user gives permission to execute “refreshment”, power supply from the connected AC adapter 51 is stopped by the AC adapter power stop circuit 80 to enable complete discharge of the intelligent battery 52. That is, to execute complete discharge of the secondary battery or intelligent battery 52, an ACDC-OFF signal of the embedded controller 41 is set to high level to turn on a first transistor (TR1) 82 of the AC adapter power stop circuit 80. The turn-on of the first transistor (TR1) 82 causes a second transistor (TR2) 83 to turn off. The turn-off of this transistor causes a FET (FET1) 81 to turn off, thereby stopping supply from the AC adapter 51 and, hence, supply of power to the first diode 77. Thus, supply of power from the intelligent battery 52 to the main-unit circuit via the second diode 78 is enabled even when the AC adapter 51 is connected.

When the battery is refreshed (completely discharged), the ACDC-OFF signal is set to low level to turn off the first transistor (TR1) 82 of the AC adapter power stop circuit 80. The turn-off of the first transistor (TR1) 82 causes the second transistor (TR2) 83 to turn on. This turn-on causes the FET (FET1) 81 to turn on. Electric power is thereby supplied from the AC adapter 51 higher in voltage than the intelligent battery 52 to the main-unit circuit (main-unit system). It is possible to remove the memory effect from the intelligent battery 52 by the above-described sequence of operations.

On the other hand, on the system side, the remaining capacity (e.g., the charge level (%)) is displayed by using, for example, LCD 18 on the basis of the value of remaining capacity obtained from the intelligent battery 52. The remaining capacity can be grasped by the CPU 62 in the intelligent battery 52 on the basis of, for example, the current value measured with the current measuring circuit 63 and the voltage value measured with the voltage measuring circuit 70. There is a problem of an error in the remaining capacity due to self discharge becoming considerably large in a situation where the intelligent battery 52 is left for a long time (a predetermined period) after being removed from the system (computer system 10), or in a situation where the system is not used during a long time (a predetermined period) while the intelligent battery 52 is connected to the system. In such a situation, refreshment (complete discharge) is required to improve the accuracy of the remaining capacity by removing the capacity error for the purpose of achieving indication of the remaining capacity with the desired accuracy, etc. However, a refreshment execution method, such as that used in the conventional art, based on the number of counts of incomplete charge and discharge is not effective in reducing the capacity error.

Then, a battery diagnosis program for executing refreshment (a utility program executed by the CPU 11 in the computer system 10) is written so that the identifier (serial number) of the intelligent battery 52 and the date on which complete discharge of the intelligent battery 52 is last performed (the date on which refreshment is executed or the date on which the battery is completely discharged by being used for battery drive by a user) are recorded in a file (or a memory). This program makes it possible to urge the user by using, for example, the LCD 18 to perform refreshment for indication of the remaining capacity with improved accuracy even in a case where the intelligent battery 52 is not completely discharged during a predetermined period and the error in the remaining capacity is large.

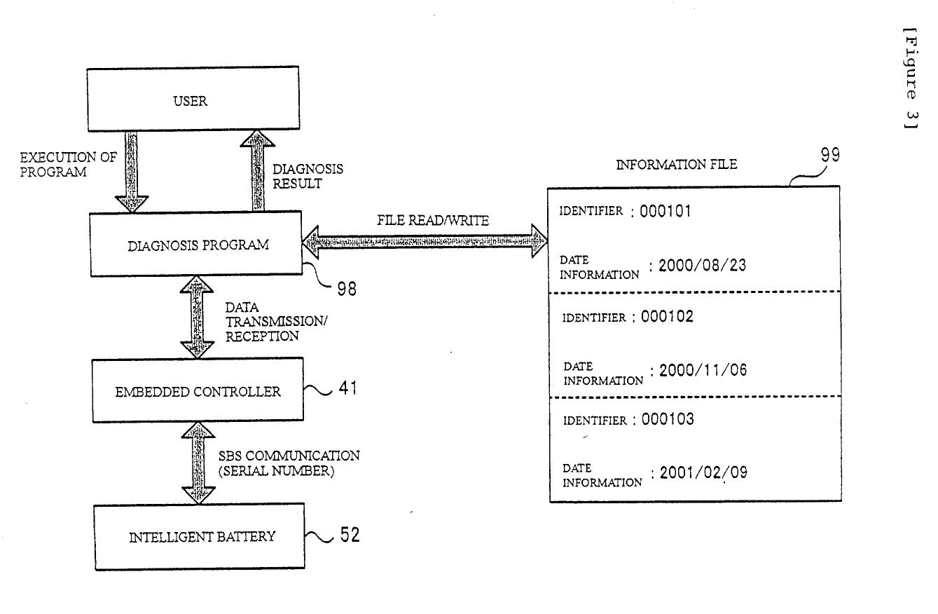

FIG. 3 is a diagram showing processings under the battery diagnosis program (utility program) for determination as to whether there is a need for refreshment. When a user executes the diagnosis program (utility program) 98, the diagnosis program communicates data to and from the embedded controller 41 and outputs a diagnosis result to the user (through a display, for example). In an information file 99, information including the identifier of the intelligent battery 52 and information on the date of the last refreshment related to the identifier are stored. For example, the information file 99 may be stored in the HDD 31 shown in FIG. 1. Also the information file 99 may be stored in another storage in the computer system 10.

At this step, after confirming the connection of intelligent battery 52 through the battery connection check terminal 76, the embedded controller 41 receives the identifier (serial number) of the intelligent battery 52 through the communication line 74 by, for example, SBS communication. On the other hand, the identifier of the intelligent battery 52 and information on the date of the last execution of the refreshment function, etc., are stored in the information file 99, as described above. The diagnosis program (utility program) 98 obtains the current date from the OS and, if a predetermined period of time, e.g., one month or longer has passed since the date of the last execution of the refreshment function, urges the user through a display to execute the refreshment function and displays (makes active) a button to be operated by the user to designate the refreshment function. When the user clicks the button in this display to execute the refreshment function, the date related to the identifier in the information file 99 is updated.

At this step, the predetermined time period is set to, for example, one month to cope with a memory effect resulting from an actual mode of use by a user in which charge and discharge are each performed one time in a day and the use period in one month is 20 to 22 days (that is, incomplete charge and discharge are repeated 20 to 22 times in one month). This method times execution of refreshment more suitably with respect to actual use by a user than the method using an ordinary count (e.g., 30 times). Since it is desirable to show the remaining capacity to a user by removing an error in a cycle of about “one month”, “one month”, for example, is selected as the above-mentioned predetermined period. The predetermined period can be set as desired according to a kind of battery, a mode of use, etc.

Further, the first time the intelligent battery 52 is connected, no refreshment date information to be stored in the information file 99 exists. The first time the intelligent battery 52 is connected, therefore, the date of connection is stored as a date information initial value by being related to the identifier obtained from the battery.

Next, a process including the above-described processings will next be described.

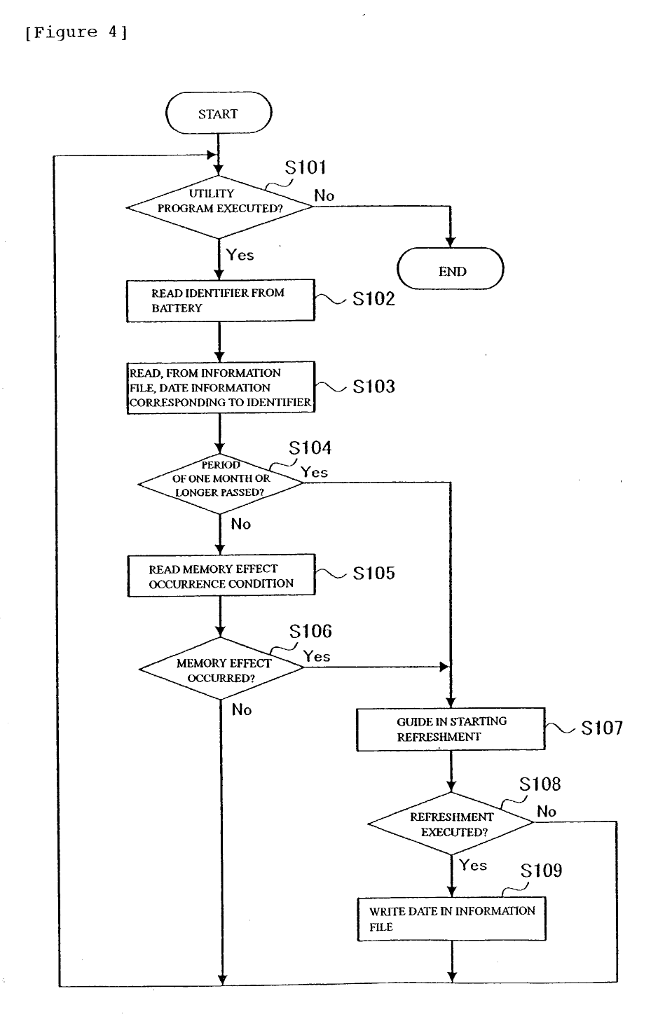

FIG. 4 is a flowchart of the process of performing the refreshment guidance function in accordance with the present invention. If the diagnosis program (utility program) 98 is executed (step 101), it reads the identifier from the intelligent battery 52 through the embedded controller 41 (step 102). The diagnosis program (utility program) 98 also reads date information corresponding to the read identifier from the information file 99 (step 103).

Next, for determination as to necessity to perform refreshment, a determination is made as to whether a predetermined period (fixed period), e.g., one month has passed from the date designated by the read date information (step 104). If the period has not yet passed, a condition relating to occurrence of a memory effect is read out (step 105). More specifically, a situation to be checked as data for ascertaining whether a memory effect has occurred, e.g., a situation in which incomplete charge and discharge have been repeated 30 times is read out. From such a situation read out, a determination is made as to whether a memory effect has occurred (step 106). If occurrence of a memory effect is not recognized, the process returns to step 101. If it is determined that a memory effect has occurred, the process advances to step 107.

If it is determined in step 104 that a period of time equal to or longer than one month has passed, and if it is determined in step 106 that a memory effect has occurred, refreshment guidance using, for example, LCD 18 is given to the user (step 107). For example, a button (execution start instruction button) is shown to the user to urge the user to perform refreshment. A determination is then made as to whether the user under this guidance has input an instruction to execute refreshment (step 108). If the user has not input any instruction, the process returns to step 101. If the user has input the instruction, date information is written to the information file 99 (step 109), thereby completing the process.

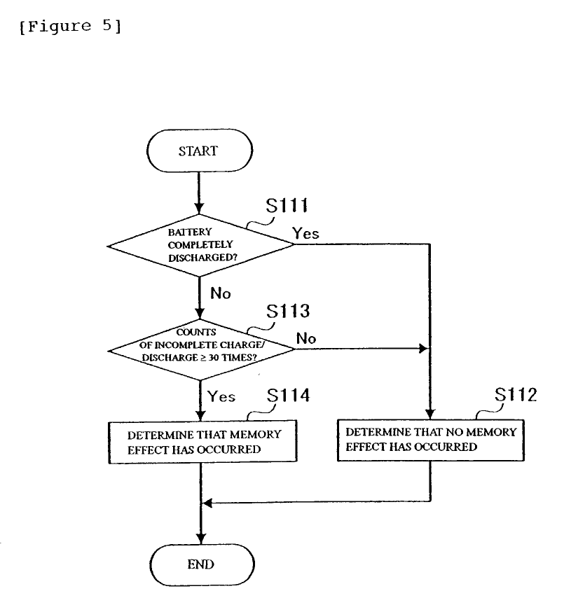

FIG. 5 is a flowchart showing an example of processing in step 106 shown in FIG. 4, i.e., processing for detecting a memory effect in the intelligent battery 52. The CPU 62 of the intelligent battery 52 makes a determination as to whether the battery is completely discharged (step 111). “Complete discharge” not only denotes full discharge to 0% but also covers a case where discharge is performed to a charge level low enough to remove a memory effect (for example, a charge level of 3% or 5% or the like). If it is determined in step 111 that complete discharge has been effected, it is then determined that no memory effect has occurred (step 112). On the other hand, if it is determined in step 111 that that battery is not completely discharged, a determination is made as to whether the number of times incomplete discharge has been performed, counted by the CPU 62, exceeds, for example, 30 (step 113). If the number of counts of incomplete discharge does not exceed 30, it is determined that no memory effect has occurred (step 112). If the number of counts exceeds 30, it is determined that a memory effect has occurred (step 114).

As a memory effect occurrence detection method, a method is known which is characterized by taking notice of the fact that a battery in which a memory effect has occurred has a nominal voltage value smaller than that of a normal discharge characteristic. That is, this method comprises-measuring the voltage of the battery during discharge and determining that a memory effect has occurred when detecting a battery voltage level excessively low with respect to the discharge current value. This method enables more accurate detection of a memory effect during ordinary operation.

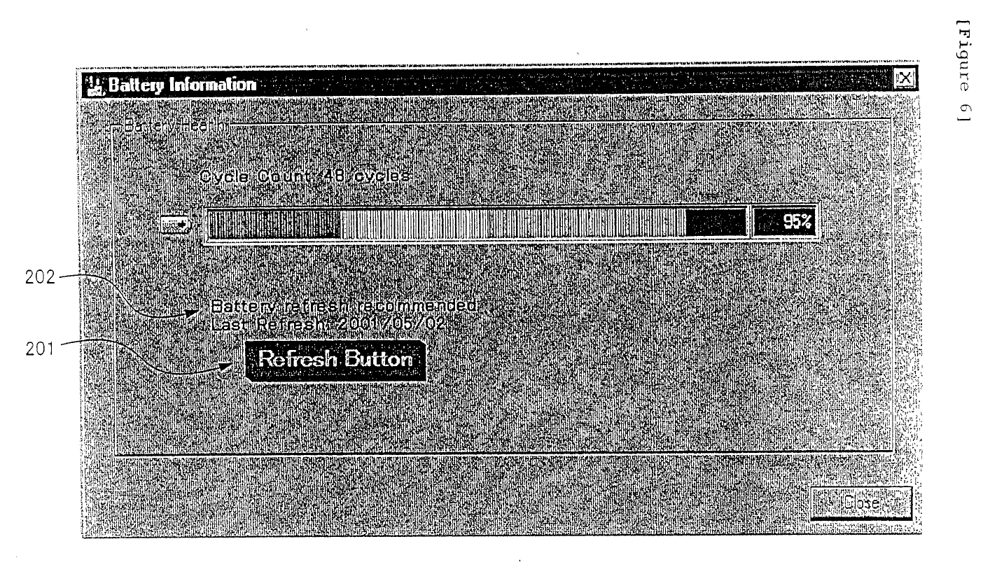

An example of an output to a user will next be described. FIG. 6 is a diagram showing an example of an on-screen display for guiding a user to execution of refreshment. Such refreshment guide information is displayed, for example, on the liquid crystal display (LCD) 19 shown in FIG. 1 by execution of the diagnosis program (utility program) 98 receiving information from the embedded controller 41. In the example of the display shown in FIG. 6, a state of a battery after 48 charge/discharge cycles is indicated. A reduction of 5% from the initial 100% capacity has been caused and the full charge capacity is 95% of the initial capacity. A color display of the capacity with a stepped or continuous change in color, for example, may be produced. For example, when the full charge capacity is 51 to 100%, there is no need to change the battery and a graph indicating the capacity is therefore displayed in green. When the full charge capacity is 31 to 50%, the graph is displayed in yellow for indication of the time to change the battery. When the full charge capacity is 0 to 30%, there is a possibility of occurrence of a functional fault such as low hibernation and the graph is therefore displayed in red. In this manner, the user can be visually informed of the degree of degradation of the battery and the time to change the battery.

At this step, a low battery hibernation function may be used which is a function for forcibly saving various statuses in PC operation to a disk when a predetermined lower limit capacity level of the battery (intelligent battery 52) is reached. Ordinarily, even when the lower limit capacity level of the battery is reached, power remaining in the battery can be used to operate the disk so as to complete the necessary saving operation. However, if the battery is degraded, there is a possibility of the capacity decreasing abruptly when the predetermined lower limit capacity level is reached. In such an event, supply of power from the battery may be stopped before the saving operation is completed. In this embodiment, therefore, the necessary indication is given in red to specially alert the user to the possibility of such a failure. Further, in this embodiment, simultaneously with the above-described display, a refreshment instruction button 201 and a refreshment recommendation message 202 are displayed. The refreshment recommendation message 202 includes a message “Battery Refresh Recommended” and information on the date of most recent (last) execution of refreshment. Through this display, it is possible to recommend (urge) the user to start the refreshment operation at a suitable time without the risk of reducing the battery life. When the refreshment instruction button 201 is clicked by the user, the diagnosis program (utility program) 98 issues a refreshment instruction to the embedded controller 41. Then, the embedded controller 41 sets the ACDC-OFF signal to high level to turn off the FET (FET1) 81 in the AC adapter power stop circuit 80, thereby stopping power supply from the AC adapter 51. Refreshment is thus executed.

In this embodiment, as described above, a user is guided in starting refreshment of the battery at a suitable time in such a manner that occurrence of an error in the remaining capacity of the battery is predicted and guidance for refreshment (complete discharge) is given to the user, thus making it possible to show the remaining capacity to the user without an error. Although there is a problem of an error in the remaining capacity of the battery due to self discharge becoming considerably large if the battery is left detached from a system for a long time or if the system is not used during a long time while the battery is connected to the system, the system in this embodiment is capable of refreshment for reducing the capacity error for the purpose of improving the accuracy of the remaining capacity and, therefore, capable of indicating the remaining capacity of the battery to the user with accuracy.

As mentioned above, “complete discharge” referred to in the description of this embodiment not only denotes full discharge to 0% but also covers discharge to a charge level of about 3% to 5%, necessary for removing a memory effect. Then, “refreshment” can be defined as continuing discharge until a predetermined battery capacity value is reached while no charging power is supplied to the battery (intelligent battery 52). The arrangement may be such that this capacity can be set by a user. Examples of a mode of discharge recognized as “completion of refreshment” are (1) continuous discharge to a capacity of 10% in a case where the lower limit capacity is set to 10% by a user, (2) continuous discharge to a capacity of 3% (according to the Windows (R) specifications provided by Microsoft Corp., discharge to a level lower than 3% is to be avoided), and (3) continuous discharge to a capacity of 0%. Most preferably, the lower limit of the battery capacity is set to about 3% by considering computation of the full charge capacity of the battery based on integration of the amount of discharge from the battery, or for the purpose of effectively removing a memory effect in the battery.

“Refreshment” may be started in such a manner that if a user selects the refreshment function in the diagnosis program (utility program) 98 in the PC (on main unit side), the PC stops charge from the AC adapter 51 to the battery to start power supply from the battery to the main unit. Thus, a user may intentionally start refreshment. Also, refreshment may be completed in such a manner that the predetermined capacity value is reached during a process in which supply of power from the battery to the main unit is continued without connecting the AC adapter 51.

The above-described diagnosis program (utility program) 98 may be provided in such a manner that it is installed in the computer system 10 in advance or it is read from a CD-ROM provided as a program storage medium by the CD-ROM drive 32 to be executed. Also, the diagnosis program may be installed from an external program transfer device through a network, e.g., the Internet.

In the above-described arrangement, the information file 99 shown in FIG. 3 is provided on the system side and nonperformance of refreshment of the battery through a time period equal to or longer than a certain period is detected by the diagnosis program (utility program) 98. The arrangement may alternatively be such that date information is provided in the intelligent battery 52 and the CPU 62 in the intelligent battery 52 detects nonperformance of refreshment of the battery through a time period equal to or longer than a certain period.

In such a configuration, the intelligent battery 52 stores information on the date of most recent (last) execution of refreshment thereof in a memory, e.g., one incorporated in the CPU 62. In this case, there is no need to prepare the information file 99 shown in FIG. 3, or the like for storing date information corresponding to the identifiers of different batteries. The CPU 62 makes determination as to necessity to perform refreshment by using such date information if a predetermined period (e.g., one month or longer) has passed. The result of this determination can be transmitted to the system side through the embedded controller 41 by using the SBS protocol. The utility program informed of necessity to perform refreshment displays on the LCD 18 information such as shown in FIG. 6 and waits for a refreshment instruction from a user. When the refreshment operation is completed after receiving the refreshment instruction, the CPU 62 of the intelligent battery 52 updates the date information and stores this information in a predetermined memory.

The configuration in which information on the date of the most recent (last) execution of refreshment is held in the intelligent battery 52 and the system is notified of a result of determination as to necessity to perform refreshment is advantageous in that the need for identification of each of intelligent battery 52 with respect to variations in technologies and different makers is eliminated. Also, one intelligent battery 52 can be suitably used in a plurality of computer systems 10. The utility program used in such a mode has the function of producing an on-screen display such as shown in FIG. 6 by receiving information from the embedded controller 41, recognizing the user operation on a refreshment instruction button 201 such as shown in FIG. 6, and transmitting the recognized instruction to the embedded controller 41. According to the present invention, as described above, a user can be guided in making a suitably timed start on refreshment of a battery.

### Description of Symbols

10 . . . Computer system

11 . . . CPU

18 . . . Liquid crystal display (LCD)

41 . . . Embedded controller

31 . . . IDE hard disk drive (HDD)

50 . . . Power supply circuit

51 . . . AC adapter

52 . . . Intelligent battery

61 . . . Cell

62 . . . CPU

63 . . . Current measuring circuit

70 . . . Voltage measuring circuit

74 . . . Communication line

75 . . . Voltage measuring circuit

76 . . . Battery connection check terminal

77 . . . First diode (D1)

78 . . . Second diode (D2)

80 . . . AC adapter power stop circuit

81 . . . FET (FET1)

82 . . . First transistor (TR1)

83 . . . Second transistor (TR2)

90 . . . Temperature measuring circuit

98 . . . Diagnosis program (utility program)

We claim as our invention:

1. An electric appliance which is arranged so that a rechargeable battery can be connected thereto, and which has a main unit supplied with electric power from the battery, comprising:
an identifier recognition unit for recognizing an identifier for identification of the battery; and
an information storage unit for storing information on the date of execution of refreshment of the battery by relating the information to the identifier recognized by said identifier recognition means.

2. The electronic appliance according to claim 1, further comprising an output unit for urging a user to execute refreshment of the battery after a lapse of a predetermined time period from the date indicated by the information stored in said information storage unit.

3. The electronic appliance according to claim 1, further comprising:
an instruction receiving unit for receiving a refreshment instruction from a user; and
a refreshment execution unit for executing refreshment of the battery on the basis of the refreshment instruction received by said instruction receiving unit.

4. The electronic appliance according to claim 3,
wherein said information storage unit stores information on the date of execution of refreshment by said refreshment execution unit by relating the information to the identifier.

5. The electronic appliance according to claim 1,
wherein the information on the date stored by said information storage unit is information on the date on which refreshment of the battery is last performed.

6. An electronic appliance, comprising:
a main unit which consumes electric power; and
a battery which supplies electric power to said main unit by being charged and discharged,
wherein an error in the remaining capacity of said battery due to self discharge is predicted and guidance on refreshment is performed to remove the error.

7. The electronic appliance according to claim 6,
wherein refreshment guidance is performed in a case where said battery is not refreshed during a predetermined period.

8. An electronic appliance, comprising:
a main unit which consumes electric power; and
a battery which supplies electric power to said main unit by being discharged after being charged,
wherein a display for demanding refreshment is produced after a lapse of a predetermined time period from the last execution of refreshment of the battery regardless of the number of counts of charge and discharge of the battery.

9. An electronic appliance having a main unit which consumes electric power, and a battery which supplies electric power to said main unit by being charged and discharged, comprising:
a date information storage unit for storing information on the date of the last execution of refreshment of the battery; and
a determination unit for making a determination as to necessity to perform refreshment, said determination unit determining that there is a need for refreshment after a lapse of a predetermined time period from the date indicated by the information stored in said date information storage unit.

10. A computer apparatus which is arranged so that a rechargeable battery can be connected thereto, and which has a system main unit supplied with electric power from the battery, comprising:
a CPU for executing a program for diagnosis of the battery;
a controller which receives from the battery an identifier for identification of the battery, and which outputs the received identifier to said CPU; and
an information file in which information on the date of refreshment of the battery is stored,
wherein said CPU makes a determination as to necessity to perform refreshment by obtaining the date information corresponding to the identifier output from said controller.

11. The computer apparatus according to claim 10,
wherein the system main unit is supplied with electric power from an AC adapter connected to a commercial power supply and/or from the battery, and has an AC adapter power stop circuit which supplies/stops electric power from the AC adapter to the system main unit under the control of said controller, and
said controller stops supply of electric power from the AC adapter to the system main unit by controlling said AC adapter power stop circuit on the basis of a refreshment instruction from said CPU.

12. The computer apparatus according to claim 10,
wherein said CPU outputs a refreshment guide to a user when refreshment is necessary.

13. A computer apparatus arranged so that a rechargeable battery can be connected thereto, electric power being supplied the battery to a system main unit, comprising:
a memory for storing date information on the date of the last execution of refreshment of the battery; and
a display unit for producing a display for recommending the user to perform refreshment in a case where refreshment of the battery is not performed during a predetermined time period after the date indicated by the date information stored in said memory.

14. The computer apparatus according to claim 13,
wherein said display unit displays a refreshment button for receiving a refreshment instruction from the user.

15. An intelligent battery connected to an electric appliance and charged and discharged to supply electric power to the electric appliance, comprising:
a date information storage unit for storing information on the date of refreshment; and a determination unit for making a determination as to necessity to perform refreshment, said determination unit determining that there is a need for refreshment after a lapse of a predetermined time period from the date indicated by the information stored in said date information storage unit.

16. The intelligent battery according to claim 15,
further comprising an output unit for outputting the result of determination made by said determination unit to a controller of the electric appliance.

17. A battery diagnosis method of diagnosing a battery which is charged and discharged to supply electric power to a main unit, comprising the steps of:
storing information about refreshment performed on the battery; and
determining that there is a need for refreshment of the battery if it is recognized from the stored information that refreshment is not performed during a predetermined time period.

18. The battery diagnosis method according to claim 17,
wherein if it is determined that there is a need for refreshment of the battery, a display for recommending a user to-perform refreshment is produced.

19. A program for realizing the following functions in a computer to which a battery charged and discharged to supply electric power to a main unit can be connected:
a function for reading out, from a predetermined memory, information on the date of refreshment of the battery;
a function for determining that there is a need for refreshment of the battery in a case where a predetermined time period has elapsed from the date indicated by the information read out; and
a function for producing an output for urging a user to perform refreshment.

20. The program according to claim 19,
wherein said program is also for realizing a function for receiving a refreshment instruction from the user, and a function for storing information on the date of newly performed refreshment in the memory.

21. A storage medium on which a program to be executed by a computer is stored so as to be readable by the computer, a battery charged and discharged to supply electric power to a main unit being connected to the computer,
wherein said program makes the computer execute:
a function for reading out, from a predetermined memory, information on the date of refreshment of the battery;
function for determining that there is a need for refreshment of the battery in a case where a predetermined time period has elapsed from the date indicated by the information read out;
a function for producing an output for urging a user to perform refreshment;
a function for receiving a refreshment instruction from the user; and
a function for storing information on the date of newly performed refreshment in the memory.
